(19) United States
(12) Patent Application Publication
(10) Pub. No.: US 2013/0330567 A1
(43) Pub. Date: Dec. 12, 2013

(54) REACTIVE METALLIC SYSTEMS AND METHODS FOR PRODUCING REACTIVE METALLIC SYSTEMS

(71) Applicants: Karsten Woll, St. Ingbert (DE); Frank Muecklich, Schwalbach (DE)

(72) Inventors: Karsten Woll, St. Ingbert (DE); Frank Muecklich, Schwalbach (DE)

(73) Assignee: UNIVERSITAET DES SAARLANDES, Saarbruecken (DE)

(21) Appl. No.: 13/991,180

(22) PCT Filed: Dec. 1, 2011
(86) PCT No.: PCT/DE11/75295

§ 371 Date: Aug. 16, 2013

(30) Foreign Application Priority Data
Dec. 1, 2010 (DE) 10 2010 060 937.4

(51) Int. Cl. B23K 35/24; B32B 15/01; B32B 15/16

(52) U.S. Cl. CPC B23K 35/24; B32B 15/16; B32B 15/017
USPC 428/548; 428/652; 428/607; 427/404; 427/250; 164/95

(57) ABSTRACT

The invention relates to reactive metallic systems and to methods of producing reactive metallic systems. Such systems consist of metallic particles in the form of powders or pastes, or of metallic multilayer structures.

To prevent the reaction product of the described self-propagating reactions from being a brittle material, it is suggested in the invention that the reactive metallic system be designed as a multilayer structure made up of thin layers of ruthenium and aluminium deposited sequentially one upon the other, or as a powder consisting of ruthenium and aluminium particles.

The object is established according to the invention by selecting Ru/Al as the basic system. The strongest exothermic reaction and thus the greatest amount of liberated heat are to be expected from stoichiometrically constructed reactive systems. The heat of formation is highest here. The intermetallic phase formed is advantageously RuAl, which, unlike many comparable intermetallic phases, such as NiAl, is extremely ductile at room temperature.

The invention relates to reactive metallic systems and to methods of producing reactive metallic systems. Such systems consist of metallic particles in the form of powders or pastes, or of metallic multilayer structures.

Technical applications often require the controlled release of localized heat. Examples include soldering and/or bonding in microsystem technology. One way of generating localized heat is to use reactive metallic systems in the form of metallic multilayer structures. Multilayer structures of this kind consist of thin, individual metallic layers deposited one on top of the other and having thicknesses in the nanometer range. The overall thickness of the multilayer structure may measure several tens of microns. Supplying localized heat energy, for example by means of a laser beam or an ignition spark, triggers an exothermc reaction there between the metallic elements. This reaction propagates throughout the entire multilayer structure, parallel to the individual layers, by way of heat transfer. The speed of propagation may be several m/s. The heat being generated heats the multilayer structure up to a temperature which may vary between 1000° C. and 1600° C. depending on the material combination used. This temperature, i.e. thermal energy, is ultimately exploited in diverse applications.

Use of this kind of localized heat source in the form of rapidly reacting multilayer foils to produce soldered joints, for example, minimizes heat and stress input into adjacent components. The heat is released directly in the joint gap. This method offers several advantages over conventional soldering. Firstly, no external heat source is required (except for initiating the reaction). In addition, the joining operation may be performed in an arbitrary atmosphere. The fact that the temperature of the components to be joined does not rise must be valued as being especially significant. The zone influenced by heat during the joining of special steel is restricted, at the maximum temperature, to a range of a few tens of microns around the thin reactive layer.

Numerous material combinations have been investigated within the context of reactive metallic multilayer structures. U.S. Pat. No. 6,736,942 B2 describes the systems Rh/Si, Ni/Si and Zr/Si and the systems Ni/Al, Ti/Al, Monel®/Al and Zr/Al; multilayer structures based on Ni/Al and Monel®/Al are already commercially available. Generally, from the theoretical and experimental points of view, Ni/Al is the system about which most is known.

Scientifically speaking, the described chemical reaction belongs in the field of material synthesis by means of self-propagating reactions. Such reactions may be induced both in powders and in metallic multilayer structures. The reaction products are intermetallic phases. The quantitative relationship between the powdered elements, or the layer-thickness relationship between the individual layers, determines the stoichiometry. This is adjusted such that the reactions are as exothermic as possible and thus liberate a lot of heat. The heats of formation of the various intermetallic phases provide orientation in this context. In the system Ni/Al, the B2 NiAl phase has the greatest negative heat of formation. For reactive multilayer structures, an Al:Ni layer-thickness ratio of 1.52:1 is set to obtain 1:1 stoichiometry. The obtainable temperatures depend on the materials and may reach values far in excess of 1000° C. However, the intermetallic phases formed as reaction products are very brittle at room temperature. This limits their use, particularly for applications at room temperature.

The object of this invention is thus to prevent the reaction product of the described self-propagating reactions from being a brittle material. Use of the hitherto existing material systems is very limited on account of their poor mechanical properties at low temperatures and at room temperature.

This object is established for a reactive metallic system by configuring the reactive metallic system as a multilayer structure made up of thin layers of ruthenium and aluminium deposited sequentially one upon the other.

According to the invention described here, the object is established by selecting Ru/Al as the basic system. The strongest exothermic reaction and thus the greatest amount of liberated heat are to be expected from stoichiometrically constructed reactive systems. The heat of formation is highest here. The intermetallic phase formed is advantageously RuAl, which, unlike many comparable intermetallic phases, such as NiAl, is extremely ductile at room temperature.

The choice of RuAl is explained again below in more detail. The standard enthalpy of formation H_{f} is an initial indicator for the use of reactive multilayer systems. It categorizes the metallic systems on the basis of the amount of heat that is potentially releasable. H_{f} categorizes according to the maximum available thermal energy. Another important criterion for the use of RuAl was found to be its ductility at room temperature. This parameter is characterised by the brittle-ductile transition temperature T_{BD}. Below this temperature, generally brittle behaviour is to be expected. As the thin layer cools rapidly from approx. 1000° C. to room temperature within a few ms, extrinsic stresses are generated in the layer. In the NiAl system, the layer fractures as a result of these stresses. The reason for this is the low ductility of NiAl at room temperature. Since the soldered joint is moreover exposed predominantly to low temperatures of around room temperature, the mechanical properties of the reactive metallic system at room temperature constitute one of the criteria for use of the system.

It is within the scope of the invention that the layer thicknesses of the individual layers of ruthenium and aluminium are between 10 and 500 nm.

The invention also provides for the multilayer structure to have a layer thickness of up to 100 μm.

The scope of the invention additionally extends to a method of producing reactive metallic systems, according to which method thin layers of ruthenium and aluminium are deposited sequentially, one upon the other, on a substrate in order to form a multilayer structure, the layer thickness of the individual ruthenium and aluminium layers being between 10 and 500 nm.

In this context it is to advantage that the thin layers of ruthenium and aluminium are deposited by means of physical or chemical vapour deposition.

A refinement of the invention consists in that the thin, sequentially deposited layers of ruthenium and aluminium are detached from the substrate as a multilayer structure.

A freestanding, foil-type multilayer structure is thus obtained.

The method according to the invention provides for the multilayer structure to have a layer thickness of up to 100 μm.

Ultimately, it is also within the scope of the invention that a multilayer stack is formed from a plurality of multilayers.

A multilayer stack of this kind advantageously has a total layer thickness of up to 1 cm.

The object is also established according to the invention by means of a reactive metallic system, said reactive metallic system being designed as a powder containing ruthenium and aluminium particles.

It is also possible for the powder to consist of ruthenium and aluminium particles.

The powder system is Ru/Al-based and is thus made up (exclusively or among other constituents) of powdered ruthenium and aluminium. Alternatively, the powder is made up of aluminium-coated ruthenium particles and/or ruthenium-coated aluminium particles. The invention thereby encompasses reactions between two particles and within a particle.

The particles preferably have a mean diameter of 10 to 100 nm.

It is within the scope of the invention that the reactive metallic system takes a form suitable for thick-layer applications, in particular a powder, paste or ink form.

The advantages obtained with this invention relate to a plurality of areas. If one considers, firstly, the soldering or bonding sector, the major advantage to be expected is an increase in the joint's mechanical loading capacity due to the significant increase in room-temperature ductility shown by the RuAl phase remaining in the joint. Secondly, temperature measurements performed by the inventors show that temperatures in the Ru/Al multilayers reach values in excess of at least 1850° C. Such values have not been reached in hitherto-existing multilayer systems. For example, the temperatures are around 400° C. higher than in commercially available Ni/Al NanoFoil layers. The same applies to powder systems. The invention will therefore enable new fields of application for reactive metallic systems to be tapped. The reactive multilayer structures according to this invention may be used, for example in manufacturing, to generate localized heat for large-area joining of two planar metallic elements. It is to advantage here that, on account of the heat generation being localized, damage to any neighbouring heat-sensitive components is prevented. By virtue of the fact that the RuAl phase is an excellent electrical conductor, the multilayer structures according to the invention may be used in all areas in which electrical conductivity is important.

The invention is described in detail below by reference to the drawings and an embodiment of a reactive Ru/Al-based multilayer structure.

The drawing in

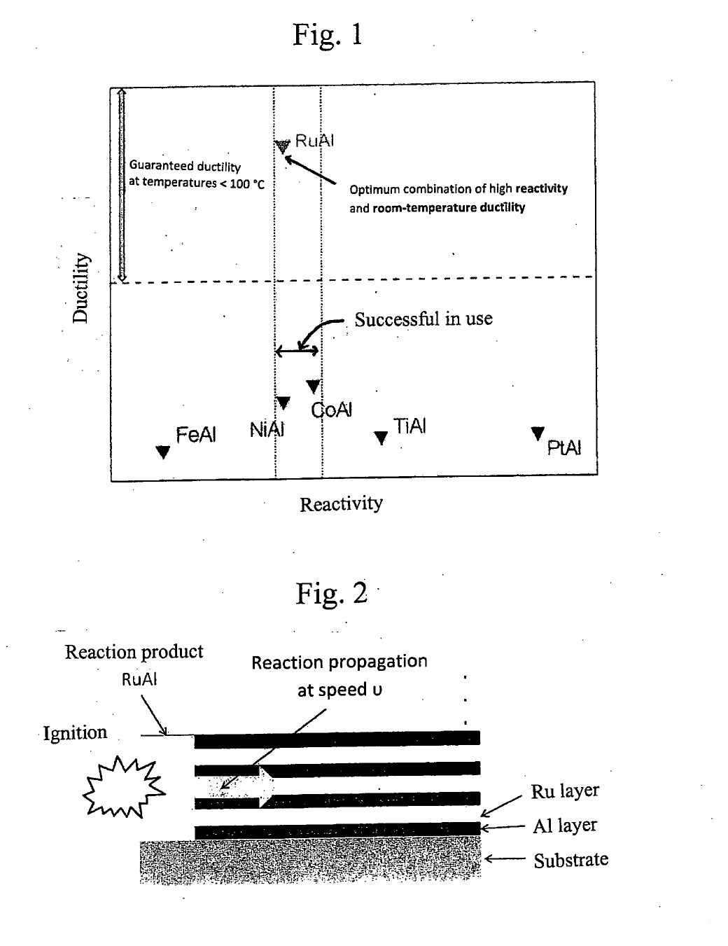

FIG. 1 shows the reactivity (=H_{f}) and ductility (=1/T_{BD}) of reactive multilayer structures investigated,

FIG. 2 is a schematic representation of the processes during the reaction,

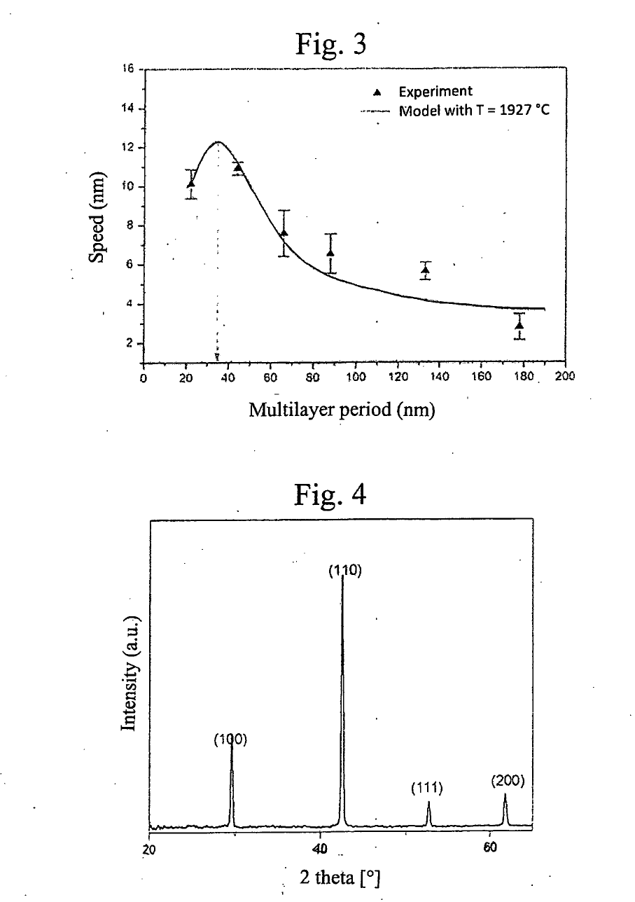

FIG. 3 is a plot of speed as a function of multilayer period (sum of the individual layer thicknesses) for self-propagating reactions in binary Ru/Al multilayer structures,

FIG. 4 is an X-ray diffractogram of a Ru/Al multilayer structure after the reaction, and

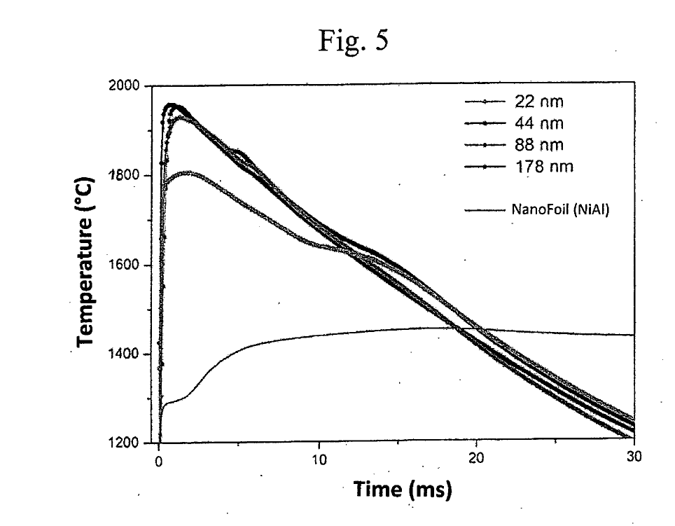

FIG. 5 shows temperature curves for Ru/Al multilayer structures with periods between 22 and 178 nm.

In FIG. 1, 1/T_{BD} is plotted against H_{f} to characterise ductility and reactivity. Components have already been successfully joined with Ni/Al and Co/Al multilayer structures. This reactivity range may thus be considered sufficient for the use of these systems. By contrast, the ductility of the intermetallic aluminides at room temperature is inadequate in both systems. NiAl and CoAl are brittle at room temperature and are characterised by a T_{BD} of 400 and 300° C. respectively. If, for purposes of material optimisation, one specifies guaranteed ductility at temperatures below 100° C., a property window showing the best combination of reactivity and room-temperature ductility is defined in FIG. 1. The intermetallic RuAl phase falls within this window. It shows an unparalleled combination of high reactivity (H_{f}=48 kJ/mol) and high room-temperature ductility (T_{BD}<23° C.). The heat of formation of the B2 RuAl phase is comparable with that of NiAl (cf. FIG. 1).

Reactive Ru/Al multilayer structures which form a B2 RuAl phase are thus promising with respect to material optimisation of reactive metallic multilayers.

The invention is described in detail on the basis of FIG. 2.

Thin layers of ruthenium (Ru) and aluminium (Al) are deposited sequentially, one upon the other, on a suitable substrate by means of thin-layer methodology (physical or chemical methods of vapour deposition). The layer thickness of the individual Ru and Al layers ranges from 10 to 500 nm. The overall layer thickness of a multilayer stack of this kind reaches values up to 1 cm (depending on the application in question). The multilayer may then be detached from its substrate. A laser beam, ignition spark or naked flame is used to heat the Ru/Al multilayer locally and thereby induce the exothermic chemical reaction of Ru and Al to form RuAl. The heat thereby liberated induces phase formation in the immediate vicinity. This reaction spreads, parallel to the individual layers and at speeds ν between 2 and 11 m/s, throughout the multilayer system by way of atomic diffusion and heat transfer (cf. FIG. 3).

By selectively choosing what is known as the multilayer period, i.e. the sum of the individual layer thicknesses, it is possible to control the reaction conditions and hence the speed. In the case of binary Ru/Al multilayers, the reaction product is the intermetallic RuAl phase. If Ru/Al-based systems containing additional components are used, corresponding RuAl-based alloys are formed.

X-ray diffraction investigations performed by the inventors clearly show that, in the former case, the intermetallic RuAl phase had indeed formed as a single phase in the described layers (cf. FIG. 4). Alone the RuAl-phase reflexes still require identification.

Temperature measurements performed by the inventors via high-speed pyrometry additionally provide evidence that temperatures of at least 1850° C. are reached during the reaction (cf. FIG. 5).

The same applies to powder systems as well. The structural feature common to both systems are the small layer thicknesses in the case of multilayer systems and, in a powder system, the particle sizes, which are of a similar dimension. This structural characteristic makes for short diffusion paths between the reaction partners, thus favouring the reaction between ruthenium and aluminium.

1: Reactive metallic system, wherein the reactive metallic system is configured as a multilayer structure made up of thin layers of ruthenium and aluminum deposited sequentially one upon the other.

2: Reactive metallic system according to claim 1, wherein the layer thicknesses of the individual layers of ruthenium and aluminum are between 10 and 500 nm.

3: Reactive metallic system according to claim 1, wherein the layer thickness of the multilayer structure is up to 100 μm.

4: Method of producing producing reactive metallic systems, wherein thin layers of ruthenium and aluminum are deposited sequentially, one upon the other, on a substrate in order to form a multilayer structure, the layer thickness of the individual ruthenium and aluminum layers being between 10 and 500 nm.

5: Method according to claim 4, wherein the thin layers of ruthenium and aluminum are deposited by means of physical or chemical vapor deposition.

6: Method according to claim 4, wherein the thin, sequentially deposited layers of ruthenium and aluminum are detached from the substrate as a multilayer structure.

7: Method according to claim 6, wherein the multilayer structure has a layer thickness of up to 100 μm.

8: Method according to claim 4, wherein a multilayer stack is formed from a plurality of multilayers.

9: Method according to claim 8, wherein the multilayer stack has an overall thickness of up to 1 cm.

10: Reactive metallic system, wherein the reactive metallic system is designed as a powder containing ruthenium and aluminum particles.

11: Reactive metallic system according to claim 10, wherein the particles have a mean diameter of 10 to 100 nm.

12: Reactive metallic system according to claim 10, wherein the reactive metallic system is in a form suitable for thick-layer applications, in particular a powder, paste or ink form.
